(19) United States
(12) Patent Application Publication
(10) Pub. No.: US 2020/0224295 A1
(43) Pub. Date: Jul. 16, 2020

(54) HOT-WORKING MATERIAL, COMPONENT AND USE

(71) Applicants: ThyssenKrupp Steel Europe AG, Duisburg (DE); thyssenkrupp AG, Essen (DE)

(72) Inventors: Jens-Ulrik BECKER, Duisburg (DE); Stefan MYSLOWICKI, Monchengladbach (DE)

(73) Assignees: ThyssenKrupp Steel Europe AG, Duisburg (DE); thyssenkrupp AG, Essen (DE)

(21) Appl. No.: 16/612,467

(22) PCT Filed: May 16, 2017
(86) PCT No.: PCT/EP2017/061772

§ 371 Date: Nov. 11, 2019

(51) Int. Cl. C22C 38/32; B32B 15/01; C22C 38/28; C22C 38/26; C22C 38/24; C22C 38/06; C22C 38/04; C22C 38/02; C22C 38/00

(52) U.S. Cl. CPC C22C 38/32; B32B 15/011; C22C 38/28; C22C 38/26; C22C 38/24; C23C 2/12; C22C 38/04; C22C 38/02; C22C 38/002; C22C 38/001; B32B 15/012; C22C 38/06

(57) ABSTRACT

The invention relates to a hot-forming material composed of a three-layer composite material, comprising a core layer of a hardenable steel which in the press-hardened state has a tensile strength >1600 MPa and/or a hardness >490 HV10, more particularly a tensile strength >1700 MPa and/or a hardness >520 HV10, and two outer layers bonded substance-to-substance with the core layer and composed of a soft steel which has a tensile strength corresponding at most to one quarter of the tensile strength of the core layer in the press-hardened state, and provided on one or both sides with an anticorrosion coating, more particularly an aluminum-based coating. The invention further relates to a component and also to a corresponding use.

### TECHNICAL FIELD

The invention relates to a hot-forming material composed of a three-layer composite material.

### TECHNICAL BACKGROUND

Within the automobile industry there is a search for new solutions for reducing vehicle weight and thereby reducing fuel consumption. In order to be able to lower the weight of a vehicle, a key element is lightweight construction. This may be achieved by measures including the use of materials of increased strength. The increase in strength generally comes at the expense of capacity for bending. In order to safeguard the occupant protection that is a requirement in the case of crash-relevant components, even in spite of the increased strength to achieve lightweight construction, it is necessary to ensure that the materials employed are able to convert the energy introduced by a crash, by means of deformation. This entails a high degree of capacity to be worked, especially in the crash-relevant components of a vehicle's structure. One means of saving weight, for example, is for the bodywork and/or the chassis of a land vehicle to be given an even lighter design and construction, by means of innovative materials in comparison to the materials conventionally employed. Thus, for example, on a component-specific basis, conventional materials can be replaced with materials having thinner walls but with optimized properties. Use is made, for example of hot-forming steels, especially manganese-boron steels, of the grade 22 MnB5, for example, which in the press-hardened state have tensile strengths of around 1500 MPa and yield points of around 1100 MPa. The potential in terms of strength increase is far from being exhausted, and so, by means of corresponding alloying approaches and/or—alternatively or additionally—through optimization of the production route, there are possibilities which allow tensile strengths of up to 1900 MPa or more to be achieved/established. Generally speaking, for later use or for their processing, the hot-forming steels are provided with a zinc-based or aluminum-based, metallic coating. As a result of this, the properties, such as the ductility, for example, of the steel material, in the press-hardened state in which the steel has been shaped to form a component, may be adversely altered by comparison with an uncoated steel material in the press-hardened state. Consequently, the achievable lightweight construction potential is diminished, because, for example, the loss in ductility must be compensated by a less substantial reduction in the thickness of material, so as to continue to ensure safe behavior of a component under service conditions in the event of a crash.

In the case of hot forming, conventionally cut-to-size steel blanks are heated to austenitization temperature, before being subsequently hot-formed and cooled in a cooled mold. As a result of intense cooling, necessitating cooling rates, for example, of at least 27 K/s in the case of a 22 MnB5, the structure undergoes complete transformation from austenite to martensite, and the material, processed to a component, acquires its desired high strength in the press-hardened state. Among those skilled in the art, this process is also known by the term “press hardening”. The steels employed for this process are generally provided with an aluminum-based coating, such as an AlSi coating, for example, in order to prevent unwanted scaling when the steel blank is heated to austenitization temperature. It is possible in this way to avoid the need for components to be freed from adhering scale, by means of blasting, for example, for their later installation into a vehicle structure by means of resistance spot welding, for example, and for sufficient paint adhesion. Additionally, by means of a barrier effect, the AlSi coating makes a contribution to protecting the component from corrosion under service conditions.

In the heating of the steel blank to austenitization temperature, for example, for the choice of the residence time of the steel blank in a heating oven, there are two constraints to be considered. First it is necessary to ensure that the steel blank is heated completely through, and secondly it is necessary to ensure that complete through-alloying of the AlSi coating is achieved.

The steels envisaged for hot forming possess an alloying design which is based on carbon, manganese, and boron. In the press-hardened state, the MBW 1500 and MBW 1900 available under the commercial designation from the applicant attain tensile strengths of approximately 1500 and 1900 MPa, respectively. With both materials, a difference can be found in the residual ductility that remains after the press hardening of uncoated and of AlSi-coated material. This difference may be demonstrated, for example, in the VDA 238-100 plate bending test, in a reduced bending angle for the AlSi-coated material relative to the uncoated material. The cause of this is that in the case of the uncoated material, there may be slight edge decarburization of the steel during the press-hardening process. As a result of this, the hardness within this decarburized edge layer after cooling in the working mold is locally lower than in the undecarburized region in the interior of the material, and a martensitic structure of relatively low hardness, or even a bainitic structure, can be formed. Both forms of structure have a comparatively higher residual ductility in the interior in comparison to the martensite of the undecarburized region, and, under a bending load, this higher residual ductility possesses a lower susceptibility to the formation of initial cracks. In the case of AlSi-coated material in particular, the presence of the coating means that this process of edge decarburization does not occur, and so the edge layer of the steel possesses a comparatively higher sensitivity to cracking.

The difference in ductility between the uncoated and coated states, expressed by the achievable bending angle, increases in line with the total strength of the hot-forming material. Complemented by the fundamental tendency that the ductility, fundamentally, goes down as the strength increases, it is possible to achieve a state in which the hot-forming material achieves a profile of mechanical properties that is of interest for lightweight construction, only in the uncoated state.

### SUMMARY OF THE INVENTION

It is an object of the present invention to provide a hot-forming material which can be fabricated into a corrosion-protected, extremely high-strength component having a less crack-sensitive edge layer.

This object is achieved by means of a hot-forming material having the features of claim 1.

In order to be able to utilize the lightweight construction potential of extremely high-strength hot-forming materials, and more particularly to be able to do so without having necessary recourse to subsequent additional measures, such as blasting to remove stale, and also to be able to offer a certain barrier effect with respect to corrosion, the invention proposes a hot-forming material composed of a three-layer composite material which comprises a core layer composed of a hardenable steel which in the press-hardened state has a tensile strength >1600 MPa and/or a hardness >490 HV10, more particularly a tensile strength >1700 MPa and/or a hardness >520 HV10, preferably a tensile strength >1800 MPa and/or a hardness >550 HV10, more preferably a tensile strength >1900 MPa and/or a hardness >575 HV10, more preferably still a tensile strength >2000 MPa and/or a hardness >600 HV10, more preferably still a tensile strength >2100 MPa and/or a hardness >630 HV10, more preferably still a tensile strength >2200 MPa and/or a hardness >660 HV10, very preferably a tensile strength >2300 MPa and/or a hardness >685 HV10, and two outer layers bonded substance-to-substance with the core layer and composed of a soft steel which has a tensile strength corresponding at most to one quarter of the tensile strength of the core layer in the press-hardened state. In accordance with the invention, the hot-forming material is provided on one or both sides with an anticorrosion coating, more particularly an aluminum-based coating. The purpose of the two outer layers is solely to endow the near-surface region of the composite material with a less crack-sensitive edge layer, similar to edge decarburization, which compensates the difference in bending angle that is known for monolithic, extremely high-strength hot-forming steels (Rm >1600 MPa), between uncoated material and material provided with an anticorrosion coating, more particularly an aluminum-based coating.

In the sense of the invention, the soft steel has a tensile strength <600 MPa and/or a hardness <190 HV10, more particularly a tensile strength <550 MPa and/or a hardness <175 HV10, preferably a tensile strength <450 MPa and/or a hardness <140 HV10, very preferably a tensile strength <380 MPa and/or a hardness <120 HV10. The soft steel has properties which are particularly positive in terms of a coating and/or capacity for deformation.

HV corresponds to the Vickers hardness and is determined according to DIN EN ISO 6507-1:2005 to -4:2005.

The hot-forming material of the invention can therefore be integrated into existing, standard hot-forming operations, with no need to undertake any changes to the process chain. The coating propensity and/or deformation capacity are critically determined by the properties at the surface of the composite material, which in accordance with the invention are provided by the outer layers as, so to speak, a functional layer.

The hot-forming material may be configured, and/or provided to the further process steps, in the form of strip, plate or sheet.

According to a first embodiment of the hot-forming material, the core layer, besides Fe and unavoidable production-related impurities, in wt %, consists of
C: 0.27−0.8%.
Si: up to 0.5%.
Mn: up to 2.0%.
P: up to 0.06%.
S: up to 0.05%.
Al: up to 0.2%.
Cr+Mo: up to 1.0%.
Cu: up to 0.2%.
N: up to 0.01%.
Nb+Ti: up to 0.2%.
Ni: up to 0.5%.
V: up to 0.2%.
B: up to 0.01%.
As: up to 0.02%.
Ca: up to 0.01%.
Co: up to 0.02%.
Sn: up to 0.05%.

C is a strength-enhancing alloying element and with increasing content contributes to the increase in strength, and so the content present is at least 0.27 wt %, more particularly at least 0.30 wt %, preferably at least 0.35 wt %, more preferably at least 0.43 wt %, more preferably at least 0.48 wt %, very preferably at least 0.51 wt %, in order to achieve or establish the desired strength. With higher strength there is also an increase in the brittleness, and so the content is limited to not more than 0.8 wt %, more particularly not more than 0.75 wt %, preferably not more than 0.68 wt %, more preferably not more than 0.65 wt %, more preferably not more than 0.62 wt %, very preferably not more than 0.60 wt %, in order not to adversely affect the materials properties, and to ensure sufficient weldability.

Si is an alloying element which can contribute to the solid-solution hardening and depending on content may have positive consequences in an increase in strength, and so a content of at least 0.05 wt % may be present. In order to ensure sufficient rollability, the alloying element is limited to not more than 0.5 wt %, more particularly not more than 0.45 wt %, preferably not more than 0.4 wt %.

Mn is an alloying element which may contribute to the hardenability and may have positive consequences for the tensile strength, especially in order to bind S to form MnS, and so a content of at least 0.3 wt % may be present. In order to ensure sufficient weldability, the alloying element is limited to not more than 2.0 wt %, more particularly not more than 1.7 wt %, preferably not more than 1.5 wt %.

Al as an alloying element may contribute to the deoxidation, and a content with at least 0.01 wt %, more particularly with 0.015 wt %, may be present. The alloying element is limited to not more than 0.2 wt %, more particularly not more than 0.15 wt %, preferably not more than 0.1 wt %, in order substantially to reduce and/or to prevent precipitations in the material, particularly in the form of nonmetallic oxidic inclusions, which may adversely affect the materials properties. For example, the content may be established between 0.02 and 0.06 wt %.

Cr as an alloying element, depending on content, may also contribute to establishing the strength, especially positively to the hardenability, with a content in particular of at least 0.05 wt %. In order to ensure sufficient weldability, the alloying element is limited to not more than 0.8 wt %, more particularly not more than 0.6 wt %, preferably not more than 0.4 wt %.

B as an alloying element may contribute to the hardenability, particularly if N is being bound, and may be present with a content of at least 0.0008 wt %. The alloying element is limited to not more than 0.01 wt %, more particularly to not more than 0.008 wt %, since higher contents have adverse consequences for the materials properties and there would be a reduction in the hardness and/or strength in the material.

Ti and Nb may be alloyed in as alloying elements, individually or in combination, for making the grain finer and/or for binding N, particularly if Ti is present with a content of at least 0.005 wt %. For complete binding of N, the Ti content to be provided would be at least 3.42*N. The alloying elements in combination are limited to not more than 0.2 wt %, more particularly not more than 0.15 wt %, preferably not more than 0.1 wt %, since higher contents have deleterious consequences for the materials properties, and in particular have adverse consequences for the toughness of the material.

Mo, V, Cu, Ni, Sn, Ca, Co, As, N, P or S are alloying elements which individually or in combination, unless they are alloyed in specifically for the purpose of establishing particular properties, may be counted among the impurities. The contents are limited to not more than 0.2 wt % of Mo, to not more than 0.2 wt % of V, to not more than 0.2 wt % of Cu, to not more than 0.5 wt % of Ni, to not more than 0.05 wt % of Sn, to not more than 0.01 wt % of Ca, to not more than 0.02 wt % of Co, to not more than 0.02 wt % of As, to not more than 0.01 wt % of N, to not more than 0.06 wt % of P, and to not more than 0.05 wt % of S.

Under the aluminum-based coating, the outer layers, on account of their chemical composition, take on the effect of the edge decarburization, by forming, in the press-hardened state, a layer in the composite material—beneath the applied coating—that is less crack-sensitive in comparison to the core layer. The outer layers, besides Fe and unavoidable production-related impurities, in wt %, consist of
C: up to 0.06%.
Si: up to 0.6%.
Mn: up to 1.0%.
P: up to 0.1%.
S: up to 0.06%.
Al: up to 0.2%.
Cr+Mo: up to 0.5%.
Cu: up to 0.3%.
N: up to 0.01%.
Ni: up to 0.3%.
Nb+Ti: up to 0.25%.
V: up to 0.05%.
B: up to 0.01%.
Sn: up to 0.05%.
Ca: up to 0.01%.
Co: up to 0.02%.

In order to increase the deformability and/or coatability, C as an alloying element is limited to not more than 0.06 wt %, more particularly not more than 0.05 wt %, preferably not more than 0.035 wt %, with C being present at not less than 0.001 wt %.

Si is an alloying element which can contribute to the solid-solution hardening and may have positive consequences in an increase in strength, and so a content of at least 0.01 wt % may be present. In order to ensure sufficient rollability and/or surface quality, the alloying element is limited to not more than 0.6 wt %, more particularly not more than 0.5 wt %, preferably not more than 0.4 wt %.

Mn is an alloying element which may contribute to the hardenability and may have positive consequences for the tensile strength, especially in order to bind S to form MnS, and so a content of at least 0.1 wt % may be present. In order to ensure sufficient weldability, the alloying element is limited to not more than 1.0 wt %, more particularly not more than 0.95 wt %, preferably not more than 0.9 wt %.

Al as an alloying element may contribute to the deoxidation, and a content with at least 0.001 wt %, more particularly with 0.0015 wt %, may be present. Al is limited to not more than 0.2 wt %, more particularly not more than 0.15 wt %, preferably not more than 0.1 wt %, in order substantially to reduce and/or to prevent precipitations in the material, particularly in the form of nonmetallic oxidic inclusions, which may adversely affect the materials properties.

Cr as an alloying element, depending on content, may also contribute to establishing the strength, and may be present with a content in particular of at least 0.01 wt %. Cr is limited to not more than 0.35 wt %, more particularly not more than 0.3 wt %, preferably not more than 0.25 wt %, in order to be able to ensure substantially complete coatability of the surface.

B as an alloying element may contribute to the hardenability, particularly if N is being bound, and may be present with a content of at least 0.0002 wt %. The alloying element is limited to not more than 0.01 wt %, more particularly to not more than 0.005 wt %, since higher contents have adverse consequences for the materials properties and there would be a reduction in the hardness and/or strength in the material.

Ti and Nb may be alloyed in as alloying elements, individually or in combination, for making the grain finer and/or for binding N, with contents in particular of at least 0.001 wt % of Ti and/or of at least 0.001 wt % of Nb. For complete binding of N, the Ti content to be provided would be at least 3.42*N. The alloying elements in combination are limited to not more than 0.25 wt %, more particularly not more than 0.2 wt %, preferably not more than 0.15 wt %, since higher contents have deleterious consequences for the materials properties, and in particular have adverse consequences for the toughness of the material.

Mo, V, Cu, Ni, Sn, Ca, Co, N, P or S are alloying elements which individually or in combination, unless they are alloyed in specifically for the purpose of establishing particular properties, may be counted among the impurities. The contents are limited to not more than 0.15 wt % of Mo, to not more than 0.05 wt % of V, to not more than 0.3 wt % of Cu, to not more than 0.3 wt % of Ni, to not more than 0.05 wt % of Sn, to not more than 0.01 wt % of Ca, to not more than 0.02 wt % of Co, to not more than 0.01 wt % of N, to not more than 0.1 wt % of P, and to not more than 0.06 wt % of S.

According to a further embodiment of the hot-forming material, the outer layers each have a thickness of material of between 0.5% and 20%, more particular between 1% and 10%, based on the total thickness of the hot-forming material. The thickness of material of the outer layers ought to be calculated such that on the one hand the positive properties of the core layer are not substantially adversely affected, with the thicknesses of material of the outer layers (per side) being limited to not more than 20%, more particularly to not more than 15%, preferably to not more than 10%, very preferably to not more than 4%, based on the total thickness of the hot-forming material, in order thus to ensure the lightweight construction potential to be derived from the level of strength; an attempt is made to keep the (total) strength of the composite material as close as possible to the level of the extremely high-strength core-layer material, as monolithic material. On the other hand, the core layer has a certain distance from the surface of the hot-forming material, and so a layer is provided which is less crack-sensitive in comparison to the core layer, with the thickness of material of the outer layer (per side) being at least 0.5%, more particularly at least 1%, preferably at least 2%, based on the total thickness of the hot-forming material. The hot-forming material or, respectively, the three-layer composite material has a total thickness of material of between 0.6 and 8.0 mm, more particularly between 1.2 and 5.0 mm, and preferably between 1.5 and 4.0 mm.

According to a further embodiment of the hot-forming material, the composite material has been produced by means of cladding, more particularly roll cladding, preferably hot roll cladding, or by means of casting. Preferably the hot-forming material of the invention has been produced by means of hot roll cladding, as disclosed for example in German patent specification DE 10 2005 006 606 B3. Reference is made to that patent specification, the content of which is hereby incorporated into the present application. Alternatively the hot-forming material of the invention can be produced by means of casting, and one possibility for its production is disclosed in Japanese laid-open specification JP-A 03 133 630. The metallic production of composite material is general knowledge from the prior art.

As a result of thermal exposure, possibly, for example, during the production of composite material, preferably in the train of the hot roll cladding and in the train of the press hardening, there is diffusion of C from the core layer in the direction of the outer layer. The thinner the outer layer, therefore, the earlier the carburization from the core reaches the surface of the hot-forming material and leads to an increase in the drop in bending angle. In order to minimize the difference, in terms of the difference in the in the state with and without anticorrosion coating, according to one further embodiment of the hot-form ing material, the ratio of the C content of the core layer to the C content of the outer layer is >4, more particularly >5, preferably >6, very preferably >7, more preferably still >8, in order thereby to be able to achieve the objective with a smaller drop in the (total) strength of the hot-forming material.

According to a further embodiment of the hot-forming material, the hot-forming material satisfies the following relationship in relation to the difference of the bending angle (ΔBW) determined in a VDA 238-100 three-point bending test, in the condition with and without anticorrosion coating:

$$Δ BW < 17 ° * F , where F = \frac{tensile strength ( core layer )}{1500 MPa} as dimensionless strength relation .$$

In order to calculate the dimensionless strength relation F, the tensile strength of the core layer in the three-layer hot-forming material is compared with a monolithic hot-forming steel which serves as reference, and which corresponds to the conventionally employed grade 22MnB5 with a tensile strength of 1500 MPa. The target region of the hot-forming material, in the context of a bending angle difference in °, is situated below 17°*F. If the bending angle difference is above 17°*F, this means that the hot-forming material with anticorrosion coating becomes too brittle in comparison to the unprotected material, and there is no sufficient, economic, lightweight construction potential available from it.

According to a second aspect, the invention relates to a component produced from a hot-forming material of the invention by means of press hardening, more particularly for producing a component for automaking, railroad construction, shipbuilding or aerospace. As a result of the outer layers, a layer is formed which is less crack-sensitive in comparison to the core layer, and so the component provided with an aluminum-based coating has an improved bending angle in comparison to a monolithic hot-forming steel which has the same alloy composition as the core layer of the hot-forming material of the invention.

According to a third aspect, the invention relates to the use of a component produced from the hot-forming material of the invention in bodywork or in the chassis of a land vehicle. This vehicle preferably comprises automobiles, utility vehicles or buses, whether with an internal-combustion engine, purely electrically driven vehicles or vehicles with hybrid drive trains. The components may be used as longitudinal beams or transverse beams or pillars in the land vehicle; for example, they take the form of profiles, especially as a crash profile in the fender, door sill, side impact beam, or in regions in which zero to low deformation/intrusion in the event of a crash is required.

The present invention is elucidated in more detail below, with reference to a figure and examples.

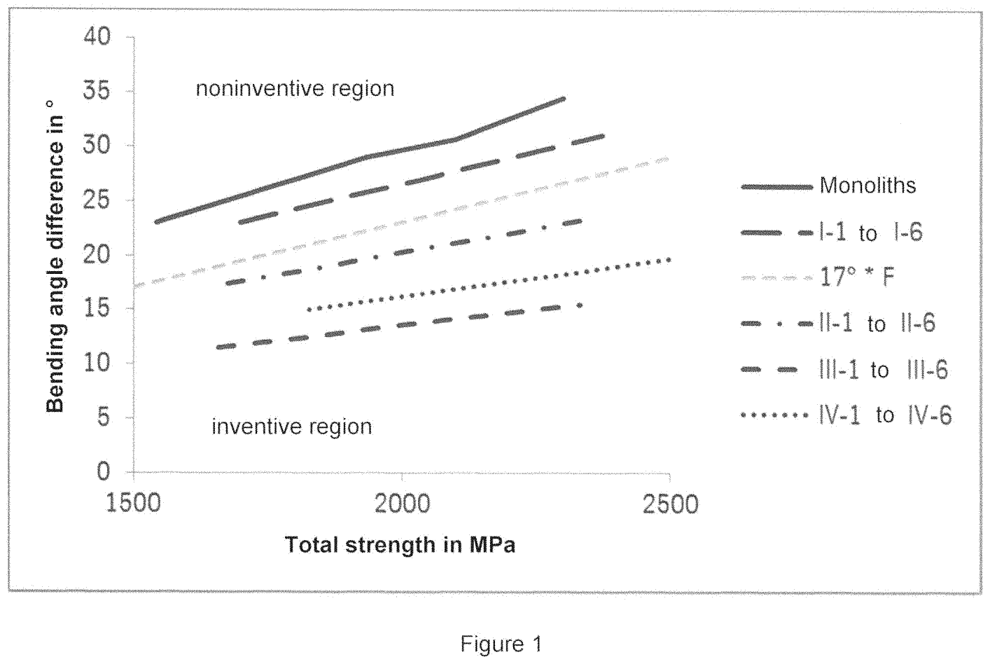

FIG. 1 shows results ascertained in a VDA 238-100 plate bending test on a variety of samples.

### EXAMPLES

From commercial flat steel products, by means of hot roll cladding, hot-forming materials were produced, comprising a three-layer composite material. Steels used as outer layers D1-D3 were those specified in table 1, and steels used as core layers K1-K6 were those specified in table 2. The listed tensile strengths in tables 1 and 2 relate to the press-hard state. In all, 24 different hot-forming materials (I-1 to IV-6) were brought together; see table 3. In the case of 18 of the hot-forming materials (I-1 to III-6), the outer layers each had a thickness of material of 10% per side, based on the total thickness of the hot-forming material, whereas for the hot-forming materials (IV-1 to IV-6), the thicknesses of material of the outer layers were only in each case 5% per side, based on the total thickness of the hot-forming material.

Here, in each case, cut-to-size sheets with two outer layers and a core layer in between them were stacked on top of one another, these sheets, at least in regions along their edges, being bonded substance-to-substance to one another, preferably by means of welding, to form a preliminary assembly. The preliminary assembly was brought to a temperature >1200° C. and in a number of steps was hot-rolled to form a composition material with a total thickness of 3 mm, and processed further into cold strip at 1.5 mm. The composite material or, respectively, the hot-forming material was coated on both sides with an aluminum-based coating, an AlSi coating having a coat thickness in each case of 20 μm. The coat thicknesses can be between 5 and 30 μm.

Blanks were divided out of the hot-forming materials produced (I-1 to IV-6). As well as the hot-forming materials, six AlSi-coated steels and six uncoated steels were also provided as reference, corresponding to the compositions in table 2, namely core layers without outer layers, with a thickness of 1.5 mm. The blanks and also the coated and uncoated monolithic steels were heated to austenitization temperature, more particularly above Acs (based on the core layer), in an oven for around 6 minutes each, and were heated through, and were subsequently subjected to hot forming and cooling in a cooled mold, in each case to form identical components. The cooling rates were >30 K/s. The core layers over the thickness were composed substantially entirely of martensite; in the transition region to the outer layer, there may additionally be ferrite and/or bainite present. In the outer layers, a mixed structure with fractions of ferrite, bainite, and—partially—martensite had been established.

Samples were cut from the press-hardened components, and were subjected to a VDA 238-100 plate bending test. The results are brought together in FIG. 1. FIG. 1 shows a diagram in which the total tensile strength in [MPa] is plotted on the x-axis and the difference in bending angle in [° ] relative to the uncoated samples is plotted on the y-axis. It is apparent that the monolithic, press-hardened samples of core materials with increasing strength, coated with an aluminum-based coating (AlSi), exhibit the greatest bending angle difference in comparison to the uncoated references. The values for the press-hardened samples obtained from the hot-forming materials of the invention are uniformly below the monolithic, press-hardened samples from core materials. Embodiments I-1 to I-6 have a bending angle difference which is too high, too similar to the monolithic hot-forming materials likewise represented, since the outer layer of embodiments I-1 to I-6 has a C content >=0.07 wt %. Owing to the thermal exposure, there is diffusion here of C from the core layer in the direction of the outer layer, and the effect of the soft outer layer is reduced. In the case of embodiments II-1 and IV-6, conversely, the C content of the outer layers is lower than in the case of embodiments I-1 to I-6, so creating a greater potential for carburization in the sense of a buffer. As a result, a lower bending angle difference is established. The C content in the outer layer is not more than 0.06 wt %, more particularly not more than 0.05 wt %. The following relationship allows hot-forming materials of the invention (see inventive region in FIG. 1) to be delimited from noninventive embodiments:

$$Δ BW < 17 ° * F , where F = \frac{tensile strength ( core layer )}{1500 MPa} .$$

The invention is not limited to the exemplary embodiments shown or to the embodiments in the general description. Instead, the hot-working material of the invention may also be part of a tailored product, in the form, for example, of part of a tailored welding blank and/or tailored rolled blank.

TABLE 1

| | C | Si | Mn | P | S | Al | Cr | Nb | Ti | B | Rm [MPa] |
|---|---|---|---|---|---|---|---|---|---|---|---|
| D3 | 0.003 | 0.02 | 0.13 | 0.01 | 0.012 | 0.0325 | 0.05 | 0.005 | 0.007 | 0.0004 | 306 |
| D2 | 0.0375 | 0.04 | 0.25 | 0.015 | 0.015 | 0.04 | 0.06 | 0.004 | 0.004 | 0.0006 | 319 |
| D1 | 0.07 | 0.205 | 0.8 | 0.02 | 0.006 | 0.04 | 0.075 | 0.02 | 0.004 | | 458 |

TABLE 2

| | C | Si | Mn | P | S | Al | Cr | N [symbol] | N [symbol] | Ti | V | B | Ca | Rm [MPa] |
|---|---|---|---|---|---|---|---|---|---|---|---|---|---|---|
| K1 | 0.35 | 0.25 | 1.3 | 0.01 | 0.0015 | 0.035 | 0.14 | | 0.0015 | 0.0325 | | 0.0028 | | 1911 |
| K2 | 0.42 | 0.225 | 1.3 | 0.02 | 0.003 | 0.035 | 0.35 | | 0.003 | 0.0275 | | 0.003 | 0.00 [symbol] 3 | 2093 |
| K3 | 0.45 | 0.07 | 0.62 | 0.01 | 0.004 | 0.04 | 0.22 | | 0.002 | 0.026 | | 0.003 | | 2304 |
| K4 | 0.48 | 0.22 | 1.2 | 0.01 | 0.002 | 0.03 [symbol] | 0.24 | | 0.002 | 0.03 | | 0.0032 | 0.002 | 2400 |
| K5 | 0.53 | 0.23 | 1.19 | 0.01 | 0.003 | 0.03 | 0.58 | 0.2 | 0.002 | 0.025 | 0.02 | 0.003 | | 2518 |
| K6 | 0.61 | 0.39 | 1.5 | 0.01 | 0.003 | 0.04 | 0.73 | | 0.0025 | 0.03 | | 0.0035 | 0.002 | 2731 |

[symbol]

indicates data missing or illegible when filed

TABLE 3

| | | | | Proportion |
|---|---|---|---|---|
| Embodiment | Core layer | Proportion | Outer layer | (per side) |
| I-1 | K1 | 80% | D1 | 10% |
| I-2 | K2 | | | |
| I-3 | K3 | | | |
| I-4 | K4 | | | |
| I-5 | K5 | | | |
| I-6 | K6 | | | |
| II-1 | K1 | | D2 | |
| II-2 | K2 | | | |
| II-3 | K3 | | | |
| II-4 | K4 | | | |
| II-5 | K5 | | | |
| II-6 | K6 | | | |
| III-1 | K1 | | D3 | |
| III-2 | K2 | | | |
| III-3 | K3 | | | |
| III-4 | K4 | | | |
| III-5 | K5 | | | |
| III-6 | K6 | | | |
| IV-1 | K1 | 90% | D3 | 5% |
| IV-2 | K2 | | | |
| IV-3 | K3 | | | |
| IV-4 | K4 | | | |
| IV-5 | K5 | | | |
| IV-6 | K6 | | | |

1. A hot-forming material composed of a three-layer composite material, comprising a core layer of a hardenable steel which in the press-hardened state has at least one of a tensile strength >1600 MPa and a hardness >490 HV10, and two outer layers bonded substance-to-substance with the core layer and composed of a soft steel which has a tensile strength corresponding at most to one quarter of the tensile strength of the core layer in the press-hardened state, and provided on at least one side or both sidcs with an anticorrosion coating.

2. The hot-forming material as claimed in claim 1, wherein the core layer, besides Fe and unavoidable production-related impurities, in wt %, consists of
C: 0.27-0.8%,
Si: up to 0.5%,
Mn: up to 2.0%,
P: up to 0.06%,
S: up to 0.05%,
Al: up to 0.2%,
Cr+Mo: up to 1.0%,
Cu: up to 0.2%,
N: up to 0.01%,
Nb+Ti: up to 0.2%,
Ni: up to 0.5%,
V: up to 0.2%,
B: up to 0.01%,
As: up to 0.02%,
Ca: up to 0.01%,
Co: up to 0.02%, and
Sn: up to 0.05%.

3. The hot-forming material as claimed in claim 1, wherein the outer layers, besides Fe and unavoidable production-related impurities, in wt %, consist of:
C: up to 0.06%,
Si: up to 0.6%,
Mn: up to 1.0%,
P: up to 0.1%,
S: up to 0.06%,
Al: up to 0.2%,
Cr+Mo: up to 0.5%,
Cu: up to 0.3%,
N: up to 0.01%,
Ni: up to 0.3%,
Nb+Ti: up to 0.25%,
V: up to 0.05%,
B: up to 0.01%,
Sn: up to 0.05%,
Ca: up to 0.01%, and
Co: up to 0.02%.

4. The hot-forming material as claimed in claim 1 wherein the core layer has a C content between 0.30-0.75 wt %.

5. The hot-forming material as claimed in claim 1 wherein the outer layers each have a thickness of material of between 0.5% and 20%, based on the total thickness of the hot-forming material.

6. The hot-forming material as claimed in claim 1 wherein the composite material has been produced by means of one of cladding or by means of casting.

7. The hot-forming material as claimed in claim 1 wherein the ratio of the C content of the core layer to the C content of the outer layer is >4, more particularly >5, preferably >6, very preferably >7.

8. The hot-forming material as claimed in claim 1 wherein the hot-forming material satisfies the following relationship in relation to the difference of the bending angle (ΔBW) determined in a VDA 238-100 three-point bending test, in the condition with and without anticorrosion coating:
$$Δ BW < 17 ° * F , where F = \frac{tensile strength ( core layer )}{1500 MPa} as dimensionless strength relation .$$

9. The hot-forming material as claimed in claim 1 wherein hot-forming material is part of a tailored product.

10. The hot-forming material of claim 1 wherein the hot forming material is formed by means of press hardening.

11. canceled

12. The hot-forming material of claim 1 wherein the core layer has at least one of a tensile strength >1700 MPa and a hardness >520 HV10.

13. The hot forming material of claim 1 wherein the anti-corrosion coating comprises an aluminum-based coating.

14. The hot forming material of claim 4 wherein the core layer has a C content of between 0.51-0.60 wt %

15. The hot forming material of claim 5 wherein the outer layers each have a thickness of material between 1% and 10%.

16. The hot forming material of claim 7 wherein the ratio of the C content of the core layer to the C content of the outer layer is >7.

17. The hot forming material of claim 9 wherein the hot-forming material is part of one of a tailored welded blank and a tailored rolled bank.
